(19) United States
(12) Patent Application Publication
(10) Pub. No.: US 2006/0225699 A1
(43) Pub. Date: Oct. 12, 2006

(54) Emergency stop apparatus and method of use for an internal combustion engine

(76) Inventors: John E. McLoughlin, Lake Grove, NY (US); Neocles G. Athanasiades, Setauket, NY (US); Toh K. Meng, Hauppauge, NY (US)

Correspondence Address: Frank L. Hart;Attorney at Law, 8911 S. 73rd East Ave., Tulsa, OK, 74133, US

(21) Appl. No.: 11/099,306

(22) Filed: Apr. 6, 2005

(51) Int. Cl. F02D 17/04

(52) U.S. Cl. 123/350; 123/198 D

(57) ABSTRACT

Apparatus and method for releasing inert gas into the air intake manifold of an operating engine in response to the measured speed of the engine being greater than a preselected magnitude.

### CROSS REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of the Invention

The subject invention relates to apparatus and method for stopping an engine in response to greater than desired engine speed.

More particularly, the subject invention relates to apparatus and method for stopping an engine by flooding the engine with an inert gas in response to greater than desired measured engine speed.

2. Description of Related Art Including Information Disclosed Under 37 CFR 1.97 and 1.98

Internal combustion engines are sometimes frequently operated in an environment where hydrocarbon combustible gasses can be released into the atmosphere and enter the engine. In such cases, these combustible gasses can be of a concentration sufficient to cause the engine to over speed and be damaged or cause damage or generate a dangerous situation.

It is therefore desirable to provide apparatus to continuously sense the speed of the engine during operation and shut the engine down in response to the speed exceeding a preselected magnitude.

### BRIEF SUMMARY OF THE INVENTION

In one aspect of the invention, the apparatus of this invention is provided for an internal combustion engine having a drive shaft, an air intake manifold and an RPM sensor. The RPM sensor is adapted to deliver a signal responsive to the engine speed. A pressurized inert gas source is connectable to the air intake manifold. A controller is connectable to and positioned between the inert gas source and the intake manifold. The controller is connectable to the RPM sensor and adapted to receive the signal therefrom and open the inert gas source into the air intake manifold in response to the signal being greater than a preselected magnitude.

In another aspect of the invention, a method is provided for operating an internal combustion engine. The apparatus as set forth above is provided. A fuel air mixture is combusted in the engine. The engine is caused to operate and turn a shaft. The RPM of the shaft is measured. A signal responsive to said measured RPM is delivered to the controller. The signal is compared to a preseleccted set point and an inert gas is delivered to the air intake manifold in response to the measured signal being greater than said set point.

### BRIEF DESCRIPTION OF THE SEVERAL VIEWS OF THE DRAWING(S)

FIG. 1 is a frontal view of an internal combustion engine having the apparatus of this invention.

### DETAILED DESCRIPTION OF THE INVENTION

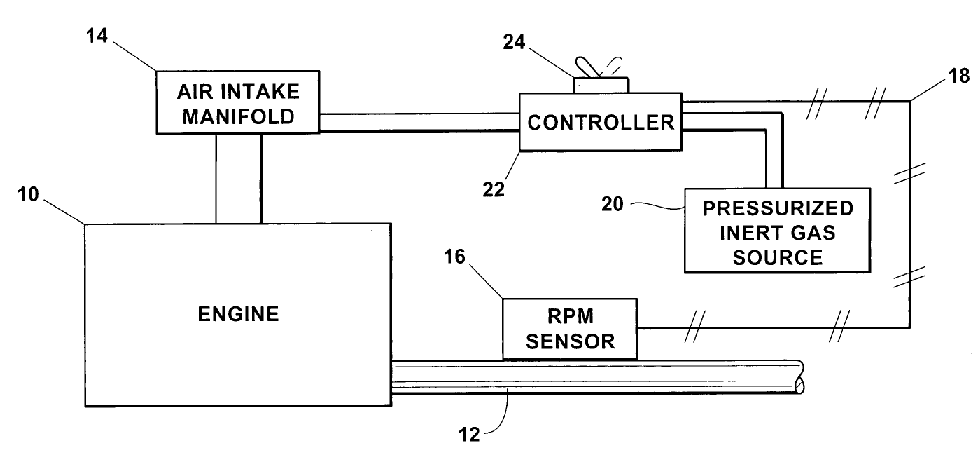

Referring to FIG. 1, an internal combustion engine 10 has a drive shaft 12, an air intake manifold 14, and an RPM sensor 16. The RPM sensor is adapted to deliver a signal, via line 18, response to the engine speed.

A pressurized gas source 20 is connectable to the air intake manifold 14. A controller 22 is connected to the RPM sensor 16 and is connectable to and positioned between the pressurized gas source 20 and the intake manifold 14. The controller 22 is adapted to receive the signal from the RPM sensor 16 and open the pressurized gas source 20 into the air intake manifold 14 in response to said signal being greater than a preselected magnitude.

A manually operated switch 24 can be connected to the controller 22 and adapted to open the pressurized gas source 20 into communication with the air intake manifold 14.

In a preferred embodiment of the apparatus of this invention, the engine speed is electrically sensed by the RPM sensor 16 and the pressurized gas is carbon dioxide. It should be understood however that the pressurized gas can be any inert gas, more preferably a non corrosive inert gas.

In the method of this invention, the apparatus, as set forth above is provided. A fuel and air mixture is combusted within the engine 10 which causes the engine to operate and turn shaft 12. The RPM of the shaft is measured by the RPM sensor 16 and a signal is delivered to the controller 22 responsive to said measured RPM. The received signal is compared to a preselected set point by the controller 22 and the controller causes inert pressurized gas to be delivered to the air intake manifold 14 in response to the measured signal being greater than said preselected set point.

During operation of the engine 10, the engine can be shut down by releasing inert pressurized gas into the air intake manifold 14 in response to actuation of a manual switch 24 that is connected to said controller 22.

Other aspects, objects, and advantages can be obtained by a study of the drawing, the specification and the appended claims.

1. In an internal combustion engine having a drive shaft, an air intake manifold, and an RPM sensor adapted to deliver a signal responsive to the engine speed, the improvement comprising:
a pressurized inter gas source connectable to the air intake manifold; and
a controller connectable to and positioned between the inert gas source and the intake manifold, said controller being connected to the RPM sensor and adapted to receive the signal therefrom and open the inert gas source into the air intake manifold in response to said signal being greater than a preselected magnitude.

2. In an engine, as set forth in claim 1, including a manually operated switch connected to the controller and being adapted to open the inert gas source into communication with the air intake manifold.

3. In an engine, as set forth in claim 1, wherein the engine speed is electrically sensed by the RPM sensor.

4. In an engine, as set forth in claim 1, wherein the inert gas is carbon dioxide.

5. A method of operating an internal combustion engine, comprising:
providing the apparatus of claim 1;
combusting a fuel and air mixture in the engine;
causing the engine to operate and turn a shaft;
measuring the RPM of said shaft;
delivering a signal responsive to said measured RPM to the controller;
comparing said received signal to a preselected set point; and
causing inert gas to be delivered to the air intake manifold in response to the measured signal being greater than said preselected set point.

6. A method, as set forth in claim 5, including:
Manually causing said controller to bring said inert gas source into communication with said air intake manifold.
